(19) United States
(12) Patent Application Publication
(10) Pub. No.: US 2007/0196008 A1
(43) Pub. Date: Aug. 23, 2007

(54) Method for noise reduction in tomographic image data records

(76) Inventors: Anja Borsdorf, Hochstadt (DE); Rainer Raupach, Adelsdorf (DE)

Correspondence Address: HARNESS, DICKEY & PIERCE, P.L.C., P.O.BOX 8910, RESTON, VA, 20195, US

(21) Appl. No.: 11/703,248

(22) Filed: Feb. 7, 2007

(30) Foreign Application Priority Data
Feb. 8, 2006 (DE) 10 2006 005 804.6

(51) Int. Cl. G06K 9/00

(52) U.S. Cl. 382/131

(57) ABSTRACT

A method is disclosed for noise reduction in 3D volume data records from tomographic recordings. In at least one embodiment, the method includes generating at least two statistically independent equally dimensioned 3D volume data records for the same location and situation. In at least one embodiment of the method, the at least two statistically independent 3D volume data records are respectively subjected to 3D wavelet transformation with low pass filtering and high pass filtering in the three spatial directions of the three dimensional volume data record, and a respective initial data record with wavelet coefficients is calculated. Further, correlation coefficients for identical wavelet coefficients are ascertained from the initial data records and a new wavelet data record is calculated by weighting the wavelet coefficients from at least one initial data record on the basis of the ascertained correlation coefficients for the wavelet coefficients from the initial data records. Finally, a new 3D volume data record is transformed back from the new wavelet data record.

### PRIORITY STATEMENT

The present application hereby claims priority under 35 U.S.C. §119 on German patent application number DE 10 2006 005 804.6 filed Feb. 8, 2006, the entire contents of which is hereby incorporated herein by reference.

1. Field

Embodiments of the invention generally relates to a method for noise reduction in tomographic image data records, for example through wavelet breakdown of two statistically independent data records, determination of the correlations between these data records and reconstruction of a new volume data record from weighted data.

2. Background

Laid-open specification DE 103 05 221 Al discloses methods for noise reduction, these involving two statistically independent, identical or spatially similar 2D sectional images or projections determining wavelet coefficients in the image plane, and the ascertained cross correlations between the wavelet coefficients being taken as a basis for using the latter, following appropriate weighting, to calculate a new image with rejection of uncorrelated components. Although such image editing rejects a large proportion of the noise, better distinction between noise which is actually present and small image structures would be desirable.

### SUMMARY

In at least one embodiment of the invention, an improved method is disclosed for noise reduction in tomographic image data records through wavelet breakdown.

The inventors have recognized, in at least one embodiment, that the reliability of the rating of correlations between the wavelet coefficients is critically dependent on the signal-to-noise ratio, which is in turn determined by the statistics of the pixels used to calculate the wavelet coefficients. In two dimensions, this involves the use of (L_{w})² pixels in each level, where L_{w} is the length of the one-dimensional filters associated with a wavelet.

In the case of short wavelets, for example Haar wavelets, the analysis is accordingly based only on very few pixels, namely four in the case of the Haar base. There is therefore the risk that the noise will have a relatively high likelihood of being interpreted as a real structure and will therefore be retained in the freshly reformatted image. This firstly reduces the maximum possible noise reduction, and secondly, with heavy weighting of the coefficients, incorrectly retained noise emerges clearly and reduces the impression of quality for the filtered image material.

The inventors, in at least one embodiment, therefore propose not only performing the wavelet breakdown in a plane of an image data record but rather extending it to the entire measured volume with all three spatial directions. This is particularly simple and effective in the case of modern CT systems, which reconstruct 3D volume data records showing an almost isotropic resolution in all three spatial directions. It is therefore possible to use the statistics not only in a plane corresponding to two spatial directions but rather in three spatial directions which are independent of one another. The closer the resolution of the 3D volume data record under consideration in the third dimension used to the resolution in a sectional plane which is at right angles thereto, that is to say the more isotropic the resolution, the better and statistically more significant use can be made of the information in this third dimension.

In the case of CT image data records, the third dimension corresponds to the z direction or system axis direction. This increases the number of pixels used for the correlation calculation to (L_{w})³, and a distinction between genuine and random correlations is improved by the factor L_{w}.

Three-dimensional wavelet breakdown includes the following coefficients, which can be classified into four groups. When classifying into groups, the division criterion used is the number of one-dimensional high pass filtering operations or low pass filtering operations when ascertaining the respective wavelet.

1st group, called “low pass component”:
TPₓ\textcircled{X}TP_{y}\textcircled{X}TP_{z}→T
2nd group, called one-dimensional “directional derivations”:
HPₓ\textcircled{X}TP_{y}\textcircled{X}TP_{z}→G^{x},TPₓ\textcircled{X}HP_{y}\textcircled{X}TP_{z}→G^{y},TPₓ\textcircled{X}TP_{y}\textcircled{X}HP_{z}→G^{z}
3rd group, called “surface diagonal components”:
TPₓ\textcircled{X}HP_{y}\textcircled{X}HP_{z}→F^{yz},HPₓ\textcircled{X}TP_{y}\textcircled{X}HP_{z}→F^{xz},HPₓ\textcircled{X}HP_{y}\textcircled{X}TP_{z}→F^{xy}
4th group, called “space diagonal component”:
HPₓ\textcircled{X}HP_{y}\textcircled{X}HP_{z}→D.

In this context, TP and HP are the one-dimensional low and high pass filters associated with the wavelet transformation, the indexes of these filters respectively representing the filter direction for high pass filtering. This produces the wavelet coefficients T, G^{x}, G^{y}, G^{z}, F^{yz}, F^{xz}, F^{xy} and D.

The three differential components from the 2nd to 4th groups contain the information about edges and noise in the frequency band of the respective level of the wavelet calculation. The correction analysis can be performed particularly advantageously on a separate basis in the various components and is then carried out for the purpose of weighting the wavelet coefficients involved.

The 1st order terms, that is to say the directional derivations G^{x}, G^{y} and G^{z}, can be used to calculate the following normalized cross correlation function in the level j, by way of example,

$${g}_{j} = \frac{{G}_{{A}_{j}}^{x} {G}_{{B}_{j}}^{x} + {G}_{{A}_{j}}^{y} {G}_{{B}_{j}}^{y} + {G}_{{A}_{j}}^{z} {G}_{{B}_{j}}^{z}}{\sqrt{{( {G}_{{A}_{j}}^{x} )}^{2} + {( {G}_{{A}_{j}}^{y} )}^{2} + {( {G}_{{A}_{j}}^{z} )}^{2}} \sqrt{{( {G}_{{B}_{j}}^{x} )}^{2} + {( {G}_{{B}_{j}}^{y} )}^{2} + {( {G}_{{B}_{j}}^{z} )}^{2}}} .$$

On the basis of gj, the wavelet coefficients G_{. . . ,j}^{x}, G_{. . . ,j}^{y}, G_{. . . ,j}^{y} can then be weighted for the purpose of noise reduction. In the simplest case, this can be done on the basis of threshold value. That is to say that all wavelet coefficients G_{. . . ,j} with gⱼ<C_{g} are set to zero and are consequently no longer included in the back transformation (wavelet synthesis). A particular advantage is the direct use of gⱼ or a power of gⱼ as a weight for the contributions by the wavelet coefficients G_{. . . ,j}^{x}, G_{. . . ,j}^{y}, G_{. . . ,j}^{y}.

The 2nd order components, that is to say the surface diagonal components F^{yz}, F^{xz} and F^{xy}, can be treated in a similar manner to the wavelet coefficients G_{. . . ,j}, that is to say that the magnitude

$${f}_{i} = \frac{{F}_{{A}_{j}}^{yz} {F}_{{B}_{j}}^{yz} + {F}_{{A}_{j}}^{xz} {F}_{{B}_{j}}^{xz} + {F}_{{A}_{j}}^{xy} {F}_{{B}_{j}}^{xy}}{\sqrt{{( {F}_{{A}_{j}}^{yz} )}^{2} + {( {F}_{{A}_{j}}^{xz} )}^{2} + {( {F}_{{A}_{j}}^{xy} )}^{2}} \sqrt{{( {F}_{{B}_{j}}^{yz} )}^{2} + {( {F}_{{B}_{j}}^{xz} )}^{2} + {( {F}_{{B}_{j}}^{xy} )}^{2}}}$$

is used to rate the correlations and to weight the coefficients F_{. . . ,j}.

By way of example, the diagonal term can be used with the following cross correlation function:

$${d}_{j} = \frac{1}{2} + {( \frac{{D}_{{A}_{j}} {D}_{{B}_{j}}}{{( {D}_{{A}_{j}} )}^{2} + {( {D}_{{B}_{j}} )}^{2}} )}^{P} ∈ [ 0 , 1 ] ,$$

where the exponent P can be used as a variable for setting the degree of selection.

In one advantageous practical implementation of at least one embodiment, the method described above can be carried out in real time. To this end, the data need to be subjected to high pass and low pass filtering online during setup of the tomographic volume data. Since, in the case of a CT, the volume data are reconstructed in line with the scanning progress along the z axis or system axis, and 3D wavelet transformation also requires data situated in the scanning direction, a certain advance needs to occur between the scan and the wavelet transformation, so that the 3D wavelet transformation trails the scan and the reconstruction by a few layers. One possible procedure for this is described in connection with FIG. 2 which follows.

In line with previously outlined basis idea of the inventors in at least one embodiment, they propose a method for noise reduction in 3D volume data records from tomographic recordings, which has at least the following method steps:
at least two statistically independent equally dimensioned 3D volume data records (A, B) for the same location and situation are generated,
the at least two statistically independent 3D volume data records (A, B) are respectively subjected to 3D wavelet transformation with low pass filtering and high pass filtering in the three spatial directions of the three dimensional volume data record, and a respective initial data record with wavelet coefficients is calculated,
correlation coefficients for identical wavelet coefficients are ascertained from the initial data records,
a new wavelet data record is calculated by weighting the wavelet coefficients from at least one initial data record on the basis of the ascertained correlation coefficients for the wavelet coefficients from the initial data records,
finally, a new 3D volume data record is transformed back from the wavelet data record or the new wavelet data records.

This method, in at least one embodiment, makes additional information available over the prior art in a further dimension in order to make a correlation decision, and this decision becomes accordingly safer. With regard to different options for obtaining statistically independent volume data records, reference is made by way of example to the previously unpublished German patent application with the file reference DE 10 2005 012 654.5, the entire contents of which are hereby incorporated herein by reference.

Advantageously, the wavelet data records may be grouped such that a first group of wavelet coefficients is obtained which are calculated exclusively by low pass filtering (TP) in the three spatial directions (x,y,z), so that the following is true: TPₓ\textcircled{X}TP_{y}\textcircled{X}TP_{z}→T. In addition, it is pointed out that this group of wavelet coefficients T always acts as an intermediate image and is broken down further in the next computation level. Hence, only the components of the wavelet coefficients which contain at least one high pass filtering operation are weighted in each computation plane j.

The wavelet data records may also contain a second group of wavelet coefficients which are calculated by two low pass filtering operations (TP) in two of the three spatial directions (x,y,z) and one high pass filtering operation (HP) in the respective remaining third spatial direction (x,y,z), so that the following is true: HPₓ\textcircled{X}TP_{y}\textcircled{X}TP_{z}→G^{x}, TPₓ\textcircled{X}HP_{y}\textcircled{X}TP_{z}→G^{y}, TPₓ\textcircled{X}TP_{y}\textcircled{X}HP_{z}→G^{z}.

Furthermore, the wavelet data records may contain a third group of wavelet coefficients which are calculated by two high pass filtering operations (HP) in two of the three spatial directions (x,y,z) and one low pass filtering operation (TP) in the respective remaining third spatial direction (x,y,z), so that the following is true: TPₓ\textcircled{X}HP_{y}\textcircled{X}HP_{z}→F^{yz}, HPₓ\textcircled{X}TP_{y}\textcircled{X}HP_{z}→F^{xz}, HPₓ\textcircled{X}HP_{y}\textcircled{X}TP_{z}→F^{xy}.

Finally, the wavelet data records may contain a fourth group of wavelet coefficients which are calculated exclusively by high pass filtering (HP) in the three spatial directions (x,y,z), so that the following is true: HPₓ\textcircled{X}HP_{y}\textcircled{X}HP_{z}→D.

Firstly, the same correlation function and/or the same rating criterion may be used as a simplification for all groups of wavelet coefficients, for example the three groups of wavelet coefficients G^{x}, G^{y}, G^{z}; F^{yz}, F^{xz}, F^{xy}and D.

A more flexible variant and one which is easier to match to the respective circumstances is when different correlation functions and/or different rating criteria are used for at least one of the three groups of wavelet coefficients G^{x}, G^{y}, G^{z}; F^{yz}, F^{xz}, F^{xy} and D. In particular, the rating of the two groups of wavelet coefficients G^{x}, G^{y}, G^{z}and F^{yz}, F^{xz}, F^{xy} may turn out to be different than for the group of wavelet coefficients D.

It is also a simple matter to make the weighting of the wavelet coefficients for the purpose of calculating the, new wavelet data record the same within all four groups of wavelet coefficients T; G^{x}, G^{y}, G^{z}; F^{yz}, F^{xz}, F^{xy} and D.

More advantageous is a flexible variant in which the weighting of the wavelet coefficients for the purpose of calculating the new wavelet data record is made different for at least two groups of wavelet coefficients T; G^{x}, G^{y}, G^{z}; F^{yz}, F^{xz}, F^{xy} and D.

In addition, the new wavelet data record can be calculated from precisely one of the at least two initial data records or from a combination of the at least two initial data records.

In one particular variant of at least one embodiment of the inventive method, the correlation function used at least for the second group of wavelet coefficients (G^{x}, G^{y}, G^{z}) may be a cross correlation function. In this case, the following function is suitable for the second group of wavelet coefficients (G^{x}, G^{y}, G^{z}), for example:

$${g}_{j} = \frac{{G}_{{A}_{j}}^{x} {G}_{{B}_{j}}^{x} + {G}_{{A}_{j}}^{y} {G}_{{B}_{j}}^{y} + {G}_{{A}_{j}}^{z} {G}_{{B}_{j}}^{z}}{\sqrt{{( {G}_{{A}_{j}}^{x} )}^{2} + {( {G}_{{A}_{j}}^{y} )}^{2} + {( {G}_{{A}_{j}}^{z} )}^{2}} \sqrt{{( {G}_{{B}_{j}}^{x} )}^{2} + {( {G}_{{B}_{j}}^{y} )}^{2} + {( {G}_{{B}_{j}}^{z} )}^{2}}} ,$$

where the indexes A and B relate to the at least two statistically independent 3D volume data records A and B, and the index j is the calculation level in the wavelet transformation.

Accordingly, the correlation function used at least for the third group of wavelet coefficients (F^{yz}, F^{xz}, F^{xy}) may be a cross correlation function. In this case, the following function is suitable, for example:

$${f}_{i} = \frac{{F}_{{A}_{j}}^{yz} {F}_{{B}_{j}}^{yz} + {F}_{{A}_{j}}^{xz} {F}_{{B}_{j}}^{xz} + {F}_{{A}_{j}}^{xy} {F}_{{B}_{j}}^{xy}}{\sqrt{{( {F}_{{A}_{j}}^{yz} )}^{2} + {( {F}_{{A}_{j}}^{xz} )}^{2} + {( {F}_{{A}_{j}}^{xy} )}^{2}} \sqrt{{( {F}_{{B}_{j}}^{yz} )}^{2} + {( {F}_{{B}_{j}}^{xz} )}^{2} + {( {F}_{{B}_{j}}^{xy} )}^{2}}} ,$$

where, in this case too, the indexes A and B relate to the at least two statistically independent 3D volume data records A and B, and the index j is the calculation level in the wavelet transformation.

Finally, the correlation function used at least for the fourth group of wavelet coefficients (D) may be a cross correlation function, where particularly the following function:

$${d}_{ j} = \frac{1}{2} + {( \frac{{D}_{{A}_{j}} {D}_{{B}_{j}}}{ {( {D}_{{A}_{j}} )}^{2} + {( {D}_{{B}_{j}} )}^{2}} )}^{P} ∈ [ 0 , 1 ]$$

is suitable. In this case too, the indexes A and B relate to the at least two statistically independent 3D volume data records A and B, the index j is the calculation level in the wavelet transformation, and the exponent P may be used as a variable for setting the degree of selection.

As an example of statistically independent volume data records, mention may be made of those which have been reconstructed from even projection values on the one hand or uneven projection values on the other hand. Also, statistically independent volume data records may come from different focus/detector combinations with an angular offset. Another possibility may also be, by way of example, to combine the projections of different spring focus positions in a spring focus system to form respective statistically independent projections and to calculate respective statistically independent volume data records therefrom.

On account of its simple design, a Haar wavelet is particularly suitable for online processing for 3D wavelet transformation. However, it should be pointed out that other transformations are also possible. For example, spline or Daubechy wavelets may be used.

The method described above, in at least one embodiment, may preferably be applied for X-ray computer tomography, with at least two statistically independent volume data records A and B, each comprising a multiplicity of voxels, being used.

Alternatively, the method, in at least one embodiment, may be applied in X-ray computer tomography, with at least two statistically independent data records A and B, each comprising a multiplicity of sectional image data records, being used and the 3D wavelet transformation being carried out across sectional images.

With regard to the use of embodiments of the inventive method in CT, it should be pointed out that said method may firstly be used to improve the image quality with a constant applied radiation dose or to reduce the radiation dose while maintaining the image quality. The same applies to application in positron emission tomography (PET) or other tomographic methods using ionizing radiation.

Furthermore, it is also within the realm of at least one embodiment of the invention for improving image quality to transfer the noise rejection method described above to volume data records from NMR tomography (NMR=Nuclear Magnetic Resonance) or ultrasound tomography.

At least one embodiment of the invention also includes a storage medium which is integrated in a processor in a tomography system or which is intended for a processor in a tomography system and which has at least one computer program or program modules which, upon execution on the processor in a tomography system, execute(s) the methods outlined above during operation.

### BRIEF DESCRIPTION OF THE DRAWINGS

The text below gives a more detailed description of the invention using the specific example embodiment of CT imaging with reference to FIGS. 1 to 4, where only the features which are required in order to understand the invention are shown. For these, the following reference symbols have been used: 1: CT system; 2: first X-ray tube; 3: first multirow detector; 4: second X-ray tube; 5: second multirow detector; 6: gantry housing; 7: patient; 8: patient's couch; 9: system axis; 10: processor and control unit; 11: internal memory; 12: volume data records; 13.1, 13.2: statistically independent volume data records; 14.1, 14.2: wavelet transformation; 15: noise rejection; 16: correlation-dependent weighting of the wavelet coefficients; 17: new volume data records; 18: inventive method; Prg,-Prg,: computer programs; A, B: statistically independent volume data records; j: computation levels; imax: maximum number of computation levels; L_{w}: length of the one-dimensional filters; P: projection; PI, PI′: statistically independent subprojections; S: radiation data record; S′, S″: statistically independent radiation data records; S₁ to Sⱼ: rays from a projection; S₁ to Sₖ: rays from the first volume element; α₁ to αₙ: projection angles.

Specifically:

FIG. 1 shows a CT system with a schematic method illustration;

FIG. 2 shows a basic outline of a wavelet transformation;

FIG. 3 shows splitting of a parallel projection into two complete subordinate parallel projections;

FIG. 4 shows splitting of a voxel scan in line with the inventive method.

### DETAILED DESCRIPTION OF THE EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

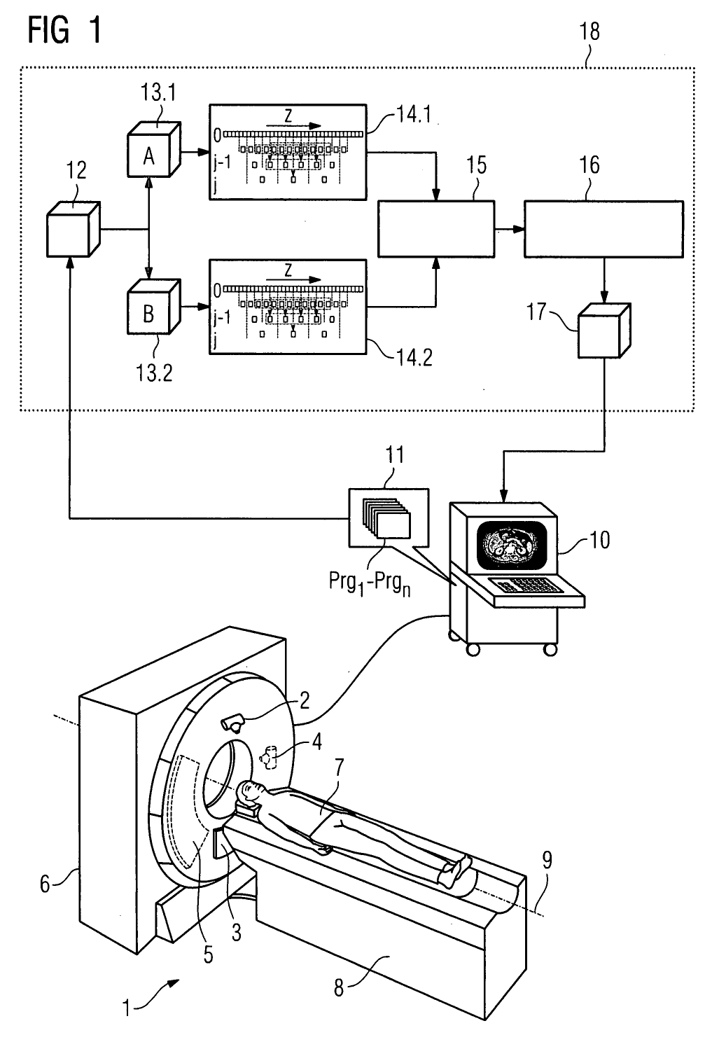

FIG. 1 schematically shows an example CT system 1 whose processor 10 applies an embodiment of an inventive noise rejection method to CT sectional image displays by executing the programs Prgₓ.

In the case specifically illustrated here, the CT system 1 has a gantry housing 6 in which an X-ray tube 2 and a multirow detector 3 are mounted on the gantry (not shown). During operation, the X-ray tube 2 and the detector 3 rotate around the system axis 9, while the patient 7 is pushed along the system axis 9 through the scanning region between the X-ray tube 2 and the detector 3 using the moveable patient's couch 8. A spiral scan is thus performed relative to the patient. Optionally, a plurality of tube/detector combinations may also be used for scanning. A second tube/detector combination of this kind is indicated in dashes by the second X-ray tube 4 and the second multirow detector 5. It should be noted that a second tube/detector combination can very easily generate a second statistically independent volume data record which is statistically independent not only with respect to the quantum noise.

Control of the CT system and also image reconstruction, including image processing with noise rejection, are effected by the processor 10, which uses an internal memory 11 to hold computer programs Prg₁-Prgₙ which could also be transferred to mobile storage media. Besides the other usual tasks of a CT computer, these computer programs also execute an embodiment of the inventive method for noise rejection during image conditioning.

The schematic illustration in FIG. 1 shows a variant of an embodiment of the inventive noise rejection in the dashed box 18. Accordingly, computer programs are first of all used to reconstruct volume data records 12 for the patient 7. From these, two statistically independent volume data records 13.1 and 13.2 are extracted for the same sectional plane and are then subjected to respective 3D wavelet transformation 14.1 and 14.2. In step 15, cross correlation coefficients are then calculated for the calculated wavelet coefficients. Next, in method step 16, the ascertained correlation between the wavelet coefficients is taken as a basis for performing correlation-dependent weighting for the wavelet coefficients during the reformatting of a new volume data record. In this context, either only the weighted wavelet coefficients for one of the two volume data records A and B or a combination of the weighted wavelet coefficients from both image data records A and B may be used.

In this way, a new volume data record 17 from which the quantum noise has been eliminated is produced which in turn can be displayed for assessment by the operating personnel on a display on the processor 10 or else can be transferred to an external computer, a data storage medium or to a printout for further assessment by a doctor.

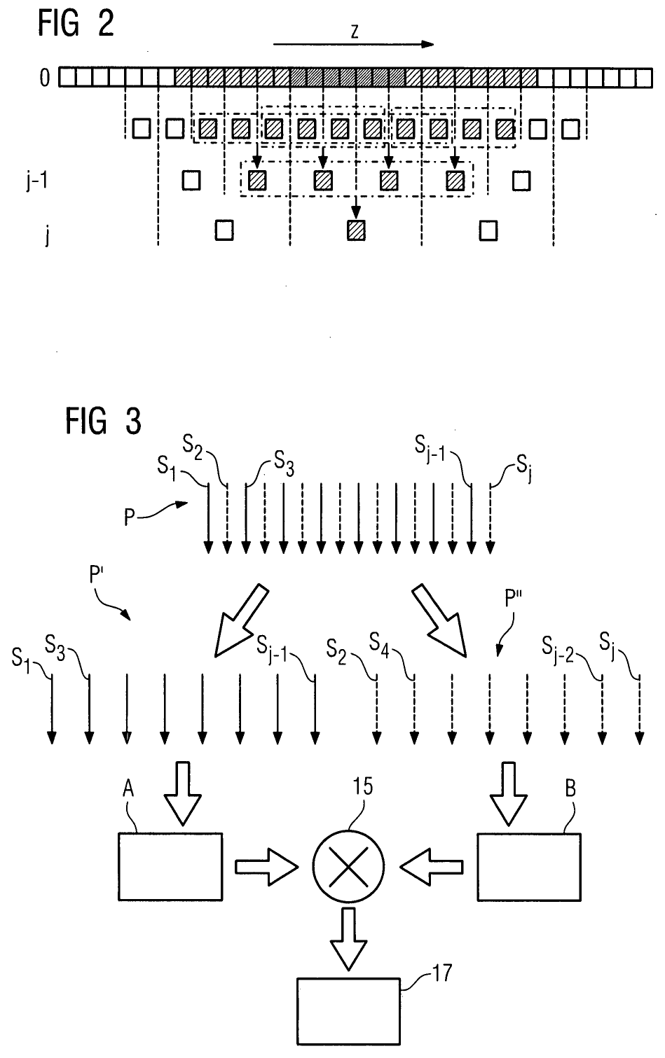

If the method described in at least one example embodiment above is intended to take place in real time, the data need to be subjected to high pass and low pass filtering online during setup of the tomographic volume data. Since the volume data are reconstructed in line with the scanning progress along the z axis or system axis 9, and 3D wavelet transformation also requires the data situated in the scanning direction, a certain advance needs to occur between the scan and the wavelet transformation, so that the 3D wavelet transformation takes place with an offset of a few layers with respect to the scan and the reconstruction. Such a situation is shown in FIG. 2, which schematically shows the wavelet breakdown in the z direction with its computation levels 0 to j, in this case for j=3 by way of example.

To be able to calculate the wavelet coefficients in a chosen xy plane at level j, 2^{j}+(2^{j}-1) (L_{w}-2) axial layers are required.

This allows the inner 2^{j} layers to be filtered. Consequently, an advance of

$$\frac{( {2}^{j} - 1 ) ( {L}_{w} - 2 )}{2}$$

images is required. When the central 2^{j} layers have been filtered, it is necessary to wait for a further 2^{j} axial images so as then to filter the inner 2^{j} layers again. This is continued iteratively until all the data have been processed.

In practice, it makes sense to limit the level of the wavelet transformation at the top by jₘₐₓ, since the significant noise components can be found in the high frequncy bands situated in the low computation levels. At the same time, this has a positive effect on the speed of processing. The noise can therefore advantageously be reduced in blocks for 2^{jmax} layers, with

$$\frac{( {2}^{j max} - 1 ) ( {L}_{w} - 2 )}{2}$$

layers of the corresponding, statistically independent volume data respectively needing to be available as an advance. After a further 2^{jmax} respective primary layers, the next block can be filtered.

The description below shows a few more variants, which do not claim to be complete, for obtaining statistically independent volume data records. One variant for splitting the available detected data for calculating independent volume data records is shown schematically in FIG. 3. This shows how a projection P, comprising a multiplicity of detector data from parallel rays S₁ to Sⱼ, is split into two complete subprojections P′ and P″.

In this case, the data which come from rays with uneven indexes are associated with the projection P′ and the data from rays with even indexes are associated with the complete subprojection P″. This method, in at least one embodiment, is carried out for all the projection angles α₁ to αₙ used, so that statistically independent volume data records A and B can then be reconstructed from the projections and the sectional images calculated therefrom. The inventive method for noise rejection 15, in at least one embodiment, is applied to these volume data records A and B, and a finished reduced-noise volume data record 17 is retransformed.

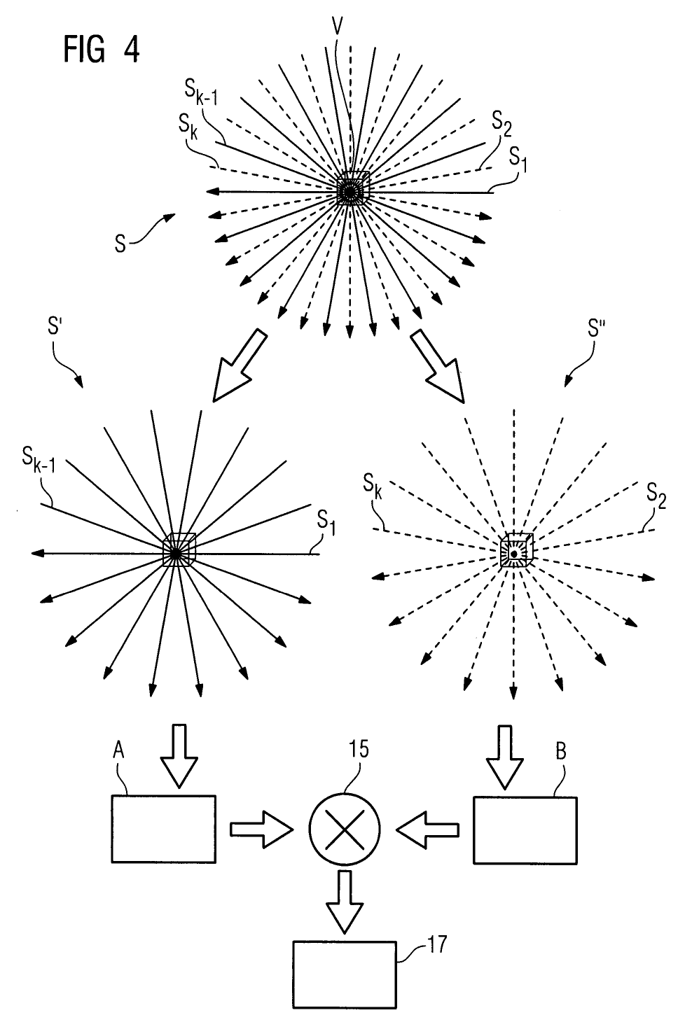

FIG. 4 shows an example of the application of an embodiment of the inventive method to a voxel-based reconstruction. In this case, the rays S₁ to Sₖ are shown which respectively penetrate a common voxel V and correspond to a 180° half revolution. In the case of voxel-based reconstruction, the individual voxel values for an examination object are reconstructed from a multiplicity of such ray sets in known fashion, and volume data records are generated.

Independent volume data records A and B can now be generated for an embodiment of the inventive method by, as schematically shown in FIG. 4, virtue of each ray set S for a voxel V, to be more precise the detector data record produced thereby, being split into complete subordinate data records which correspond to the ray sets S′ and S″. From the sum of the complete subordinate detector data records, volume data records A and B are then calculated on a voxel-by-voxel basis. These statistically independent volume data records are subjected to the inventive method for noise rejection, and then a volume data record 17 from which the noise has been removed is generated.

The examples shown above can be applied to CT data records which have been ascertained by a single focus/detector combination. If at least two focus/detector combinations or a spring focus having at least two spring focus positions is/are used then the respective data records ascertained independently of one another can be processed further in the same way.

In addition, it should be pointed out that at least one embodiment of the inventive method can be performed not only on the processors connected directly to an examination system but can also be carried out independently on separate units.

It goes without saying that the features of the invention which have been cited above can be used not just in the respectively indicated combination but also in other combinations or on their own without departing from the scope of the invention.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for noise reduction in 3D volume data records from tomographic recordings, comprising:
generating at least two statistically independent equally dimensioned 3D volume data records for the same location and situation;
respectively subjecting the at least two statistically independent 3D volume data records to 3D wavelet transformation with low pass filtering and high pass filtering in the three spatial directions of the three dimensional volume data record, and calculating a respective initial data record with wavelet coefficients;
ascertaining correlation coefficients for identical wavelet coefficients from the initial data records;
calculating a new wavelet data record by weighting the wavelet coefficients from at least one initial data record on the basis of the ascertained correlation coefficients for the wavelet coefficients from the initial data records; and
transforming a new 3D volume data record back from the new wavelet data record.

2. The method as claimed in claim 1, wherein the wavelet data records contain a first group of wavelet coefficients, calculated exclusively by low pass filtering in the three spatial directions.

3. The method as claimed in claim 1, wherein the wavelet data records contain a second group of wavelet coefficients, calculated by two low pass filtering operations in two of the three spatial directions and one high pass filtering operation in the respective remaining third spatial direction.

4. The method as claimed in claim 1, wherein the wavelet data records contain a third group of wavelet coefficients calculated by two high pass filtering operations in two of the three spatial directions and one low pass filtering operation in the respective remaining third spatial direction.

5. The method as claimed in claim 1, wherein the wavelet data records contain a fourth group of wavelet coefficients calculated exclusively by high pass filtering in the three spatial directions.

6. The method as claimed in claim 2, wherein at least one of the same correlation function and the same rating criterion is used for all four groups of wavelet coefficients.

7. The method as claimed in claim 2, wherein at least one of different correlation functions and different rating criteria are used for at least one of the three groups of wavelet coefficients which have been produced by at least one high pass filtering operation.

8. The method as claimed in claim 2, wherein the weighting of the wavelet coefficients for the purpose of calculating the new wavelet data record is made the same within all three groups of wavelet coefficients which have been produced by at least one high pass filtering operation.

9. The method as claimed in claim 2, wherein the weighting of the wavelet coefficients for the purpose of calculating the new wavelet data record is made different for at least two groups of wavelet coefficients which have been produced by at least one high pass filtering operation.

10. The method as claimed in claim 1, wherein the new wavelet data record is calculated from precisely one of the at least two initial data records.

11. The method as claimed in claim 1, wherein the new wavelet data record is calculated from a combination of the at least two initial data records.

12. The method as claimed in claim 1, wherein the correlation function used at least for the second group of wavelet coefficients is a cross correlation function.

13. The method as claimed in claim 12, wherein the cross correlation function used for the second group of wavelet coefficients is the following function:
$${g}_{j} = \frac{{G}_{{A}_{j}}^{x} {G}_{{B}_{j}}^{x} + {G}_{{A}_{j}}^{y} {G}_{{B}_{j}}^{y} + {G}_{{A}_{j}}^{z} {G}_{{B}_{j}}^{z}}{\sqrt{{( {G}_{{A}_{j}}^{x} )}^{2} + {( {G}_{{A}_{j}}^{y} )}^{2} + {( {G}_{{A}_{j}}^{z} )}^{2}} \sqrt{{( {G}_{{B}_{j}}^{x} )}^{2} + {( {G}_{{B}_{j}}^{y} )}^{2} + {( {G}_{{B}_{j}}^{z} )}^{2}}} ,$$
where the indexes A and B relate to the at least two statistically independent 3D volume data records A and B, and the index j is the calculation level in the wavelet transformation.

14. The method as claimed in claim 1, wherein the correlation function used at least for the third group of wavelet coefficients is a cross correlation function.

15. The method as claimed in claim 14, wherein the cross correlation function used for the third group of wavelet coefficients is the following function:
$${f}_{i} = \frac{{F}_{{A}_{j}}^{yz} {F}_{{B}_{j}}^{yz} + {F}_{{A}_{j}}^{xz} {F}_{{B}_{j}}^{xz} + {F}_{{A}_{j}}^{xy} {F}_{{B}_{j}}^{xy}}{\sqrt{{( {F}_{{A}_{j}}^{yz} )}^{2} + {( {F}_{{A}_{j}}^{xz} )}^{2} + {( {F}_{{A}_{j}}^{xy} )}^{2}} \sqrt{{( {F}_{{B}_{j}}^{yz} )}^{2} + {( {F}_{{B}_{j}}^{xz} )}^{2} + {( {F}_{{B}_{j}}^{xy} )}^{2}}} ,$$
where the indexes A and B relate to the at least two statistically independent 3D volume data records A and B, and the index j is the calculation level in the wavelet transformation.

16. The method as claimed in claim 1, wherein the correlation function used at least for the fourth group of wavelet coefficients is a cross correlation function.

17. The method as claimed in claim 16, wherein the cross correlation function used for the fourth group of wavelet coefficients (D) is the following function:
$${d}_{j} = \frac{1}{2} + {( \frac{{D}_{{A}_{j}} {D}_{{B}_{j}}}{{( {D}_{{A}_{j}} )}^{2} + {( {D}_{{B}_{j}} )}^{2}} )}^{P} ∈ [ 0 , 1 ]$$
where the indexes A and B relate to the at least two statistically independent 3D volume data records A and B, the index j is the calculation level. in the wavelet transformation, and the exponent P is usable as a variable for setting the degree of selection.

18. The method as claimed in claim 1, wherein a Haar wavelet is used for the 3D wavelet transformation.

19. A method, comprising:
applying the method of claim 1 in X-ray computer tomography, using at least two statistically independent volume data records, each comprising a multiplicity of voxels.

20. A method, comprising:
applying the method of claim 1 in X-ray computer tomography, using at least two statistically independent data records, each comprising a multiplicity of sectional image data records, and the 3D wavelet transformation being carried out across sectional images.

21. A method, comprising:
applying the method of claim 1 to volume data records from Nuclear Magnetic Resonance tomography.

22. A method, comprising:
applying the method of claim 1 to volume data records in Positron Emission Tomography.

23. A method, comprising:
applying the method of claim 1 to volume data records in ultrasound tomography.

24. A storage medium, at least one of integrated into a processor and for a processor in a tomography system, including at least one computer program or program modules stored thereon which, upon execution on the processor in a tomography system, executes the method as claimed in claim 1.

25. A tomography system including a processor, at least one computer program or program modules being stored thereon which, upon execution on the processor in a tomography system, executes the method as claimed in claim 1.

26. The method as claimed in claim 2, wherein the wavelet data records contain a second group of wavelet coefficients, calculated by two low pass filtering operations in two of the three spatial directions and one high pass filtering operation in the respective remaining third spatial direction.

27. The method as claimed in claim 26, wherein the wavelet data records contain a third group of wavelet coefficients calculated by two high pass filtering operations in two of the three spatial directions and one low pass filtering operation in the respective remaining third spatial direction.

28. The method as claimed in claim 27, wherein the wavelet data records contain a fourth group of wavelet coefficients calculated exclusively by high pass filtering in the three spatial directions.
